(19) United States
(12) Patent Application Publication
(10) Pub. No.: US 2016/0271880 A1
(43) Pub. Date: Sep. 22, 2016

(54) FUSED FILAMENT FABRICATION USING LIQUID COOLING

(71) Applicant: Arevo, Inc., Saratoga, CA (US)

(72) Inventors: Hemant Bheda, Saratoga, CA (US); Riley Reese, Sunnyvale, CA (US)

(21) Appl. No.: 15/072,270

(22) Filed: Mar. 16, 2016

Related U.S. Application Data
(60) Provisional application No. 62/133,666, filed on Mar. 16, 2015.

(51) Int. Cl. B29C 67/00

(52) U.S. Cl. CPC B29C 67/0085; B29C 67/0055; B29K 2071/00

(57) ABSTRACT

A FFF-based 3D printer includes a thermal management system that incorporates liquid cooling for the cooling block. In the illustrative embodiment, the thermal management system includes a coolant block that couples to the surface of the existing cooling block, a liquid-coolant reservoir, a fan for cooling the reservoir, a pump for pumping the coolant, and conduits for conducting the coolant to and from the coolant block. Embodiments of the invention provide a way to prevent or substantially reduce the incidence of clogging as otherwise occurs when attempting to print high-temperature, high-viscosity materials using FFF-based 3d printers.

### STATEMENT OF RELATED CASES

This case claims priority of U.S. Pat. App. Ser. No. 62/133,666 filed Mar. 16, 2015, which is incorporated by reference herein.

### FIELD OF THE INVENTION

The present invention relates generally to fused filament fabrication.

### BACKGROUND OF THE INVENTION

The additive manufacturing process is widely known as “3d printing.” Numerous 3d-printing methodologies have been described in prior art, the most common being solid-laser sintering (SLS), stereolithography (SLA), and extrusion-based 3d printing or fused filament fabrication (FFF).

All of these methods involve depositing a thin layer of thermoplastic or thermoset materials. In FFF, thin strands of material (referred to herein as “extrudate” once it leaves the deposition nozzle) are deposited onto a build surface. As the filament moves through the FFF system, it undergoes mechanical, chemical, and thermal changes. Deposition proceeds in a controlled pattern on the build surface to construct a 3d object.

In operation of an FFF system, a cylindrical filament of material is fed from a supply spool, etc., using a motor. At this point, the filament is at room temperature in a glassy, solid state. The filament moves through the feed motor and into a cooling block. Upon leaving the cooling block, the filament moves to a heating block for heating.

As the plug moves through the heating block, it continues heating and eventually the melting temperature of the polymer is exceeded. Once melted, the polymer is in a completely liquid, free-flowing state and exits the nozzle.

Once the liquefied polymer (extrudate) reaches the build surface (or is deposited on already-deposited layers of extrudate), it cools below its crystallization temperature. If the build chamber and build platform are close to the appropriate temperature, the polymer chains in the extrudate begin to order and align before completely solidifying. Once the build is complete, the polymer cools down to room temperature.

The thermal management of the FFF process is critical for building, in a consistent and predictable fashion, 3D objects. For example, it is clear that the heating block must be maintained above the processing or melt temperature of the polymer for the filament to melt and extrude through a small orifice (e.g., diameter between about 0.1 to 0.5 mm) in the nozzle. Furthermore, the temperature in the cooling block, which would otherwise rise due to heat conducted thereto from the heating block, must be kept below the processing/melt temperature.

The prior art controls the temperature of the cooling block using a fan that is attached directly to the cooling block. This fan removes heat from the cooling block and is able to keep the temperature in the cooling block below processing/melt temperature of the polymer feed.

Prior art 3D printers are suitable for printing parts made some polymers, such as acrylonitrile butadiene styrene (ABS), polylactic acid (PLA), and polyetherimide (PEI), but not for printing parts made from other polymers, particularly high-temperature polymers such as polyether ether ketone (PEEK), polyamide-imine (PAI) and self-reinforced polyphenylene (SRP). It is known in the art that when trying to print parts made from the aforementioned high-temperature polymers, 3D printers using FFF processing frequently clog. The root cause for that problem was not known and, as a consequence, those skilled in the art have avoided such materials when printing parts via FFF processing.

A need therefore exists for way to print parts or, more generally, objects, via FFF processing, using high-temperature polymers such as PEEK, PAI, and SRP.

### SUMMARY

The present invention provides a way to prevent or substantially reduce the incidence of clogging of high-temperature, high-viscosity materials during 3d printing via FFF processing. This facilitates using high temperature, high viscosity materials including semi-crystalline materials such as PEEK and amorphous materials such as PAI and SRP in an FFF system without the drawbacks of the prior art.

The present inventors tried a number of different approaches over a number of months to address the clogging problem. Attempts at a solution included changes to the design of the extruder, changes to the design of the extruder nozzle, alterations in extruder feed rate, and changes to the extrusion software. Nothing worked.

With the benefit of time and failed attempts, the inventors ultimately postulated that the problem—the root cause of the clogging—might relate to the amount of time in which the polymer remains in the “plug” state and the size of the “plug” state.

The plug state is a transition state that occurs when the temperature of the polymer exceeds its glass transition temperature but is lower than the melting temperature. The glass transition temperature is the temperature at which the amorphous chains in a polymer filament begin sliding past each other. Thus, at temperatures above the glass transition temperature but below the melting point, the polymer experiences a restricted movement, known as the plug state.

The plug state is a high-viscosity state. As the length of time that the material is in the plug state increases, the amount of pressure required by the feed motor to push the material through the nozzle also increases. If the time in the plug state is too long, the pressure of the system surpasses the maximum torque of the motor and the filament clogs. The same situation results if the plug state is physically too long.

The length of time that the material is in the plug state varies as a function of whether the polymer filament is semi-crystalline or amorphous. Amorphous polymers are almost entirely amorphous, wherein almost all polymer chains therein (c.a. >90%) are in an amorphous state characterized by tangled, unordered polymer chains. By contrast, semi-crystalline polymers consist of crystalline and amorphous regions, wherein the amorphous portion represents about 40% to 80% of the polymer.

As previously noted, the glass transition temperature is a temperature, unique for each material, at which amorphous chains begin moving and sliding past one another. Since semi-crystalline polymers have a lower percentage of amorphous chains, these polymers have a lower heat flow and thus lower overall chain mobility at the glass transition temperature compared to amorphous polymers. The lower heat flow for semi-crystalline polymers means the plug state for these polymers in the FFF-based 3D printing system is more rigid and viscous compared to the plug state for amorphous polymers. Therefore, for a given FFF system and a given motor torque, the plug state needs to be shorter, from both a time and size perspective, for semi-crystalline polymers compared to amorphous polymers.

The relatively higher viscosity polymers, such as PAI and SRP, also typically require a higher extrusion pressure to push the melted material through the orifice of the nozzle. The implication of this higher pressure requirement is that if a given FFF-based 3D printing system, capable of producing a given motor torque, is being used for both high viscosity polymers as well as lower viscosity polymers, the plug state for high viscosity materials must be shorter from a time and size perspective than the plug state for the lower viscosity materials.

Thus, by ensuring that the polymer feed, as its temperature rises towards the melting point, experiences a relatively small plug state, the tendency for the system to clog is significantly reduced. This was ultimately borne out by testing performed by the inventors.

Returning to the prior art, using a fan to cool the cooling block is sufficient to maintain a short plug state for lower temperature amorphous polymers, such as ABS, PLA, and PEI (because much less heat is transferred to the cooling block from the heating block). However, at the higher operating temperatures required for high-temperature semi-crystalline polymers, such as PEEK, PAI, and SRP, a substantial amount of heat is being conducted to the cooling black. A fan, as used in the prior art, which is simply circulating air from within the build chamber over the cooling block, is insufficient for providing the requisite cooling. And that is the reason for the clogging experienced in the prior art with such high temperature semi-crystalline polymers.

In accordance with the illustrative embodiment, an FFF-based 3D printing system includes a thermal management system that incorporates liquid cooling for the cooling block. In the illustrative embodiment, the thermal management system includes a coolant block that couples to the surface of the (existing) cooling block, a liquid coolant reservoir, a fan for cooling the reservoir, a pump for pumping the coolant, and tubing for conducting the coolant to and from the coolant block.

Consider, for example, FIG. 1, which depicts a simplified heat/energy balance for a prior art FFF-based 3D printer. Heat inputs to the system include heat from the extruder (the input is the energy that drives the extruder), and the heat from the heating block and the build platform (the input is the electrical energy that drives the heaters). The air being blown over the cooling block provides localized cooling, but it cannot cool the cooling block to less than the temperature of the build chamber. Furthermore, it is apparent that the build chamber temperature will rise as the processing continues since heat is not being removed from the system.

By contrast, FIG. 2 depicts the heat/energy balance for a modified FFF-based 3D printer in accordance with the illustrative embodiment of the present invention. Since the liquid coolant, which in the illustrative embodiment is propylene glycol, is stored outside of the system (i.e., outside of the build chamber), it can cool the coolant block to a significantly lower temperature than a fan that is blowing air from the build chamber across the cooling block. Furthermore, heat is removed, on a continuous basis, from the system via the heated coolant leaving the build chamber.

### BRIEF DESCRIPTION OF THE DRAWINGS

FIG. 1 depicts a heat/energy balance for the cooling block in a prior art FFF system.

FIG. 2 depicts a heat/energy balance for the cooling block of the modified FFF system in accordance with FIG. 3.

FIG. 3 depicts a modified FFF system in accordance with the illustrative embodiment of the present invention.

FIG. 4 depicts a comparison of the solid, plug, and liquid states as a function of system location for the prior-art FFF system and the modified FFF system in accordance with FIG. 3.

### DETAILED DESCRIPTION

As described in the background, in prior-art FFF systems, a fan is used to remove heat from the cooling block thereby preventing clogging and reducing pressure in the system. For most FFF systems, the cooling block is cooled by a fan that blows air (sourced from the build chamber) over the cooling block. As a consequence, the cooling block temperature is, at best, maintained at the build chamber temperature.

In accordance with the present teachings, a modified FFF system and method are disclosed wherein liquid cooling is used to reduce the temperature of the cooling block below the build chamber temperature.

FIG. 3 depicts system 100 for 3D printing, which utilizes a modified FFF-based process. System 100 includes housing 102, build chamber 104, gantry 106, fixture 110, extruder head 112, cooling block 115, heating block 122, build platform 124, controller 126, and a thermal management system, interrelated as shown. As discussed further below, a distinguishing characteristic of the thermal management system is that it uses liquid cooling to cool the cooling block. The build material for system 100 is a long filament of polymer 130 that is stored on roll 128. The polymer is fed from roll 128 into the printer.

System 100 “prints” objects utilizing fused filament fabrication processing, wherein filaments of material are extruded using an extrusion head. The system builds an object layer-by-layer through controlled deposition of the extrudate (i.e., the material exiting the nozzle of the extrusion head). The nozzle has an opening with a diameter in the range of about 0.25 to 1 mm, which produces an extrudate having a typically circular cross-section of like or somewhat smaller diameter or layer height (as small as about 0.1 mm).

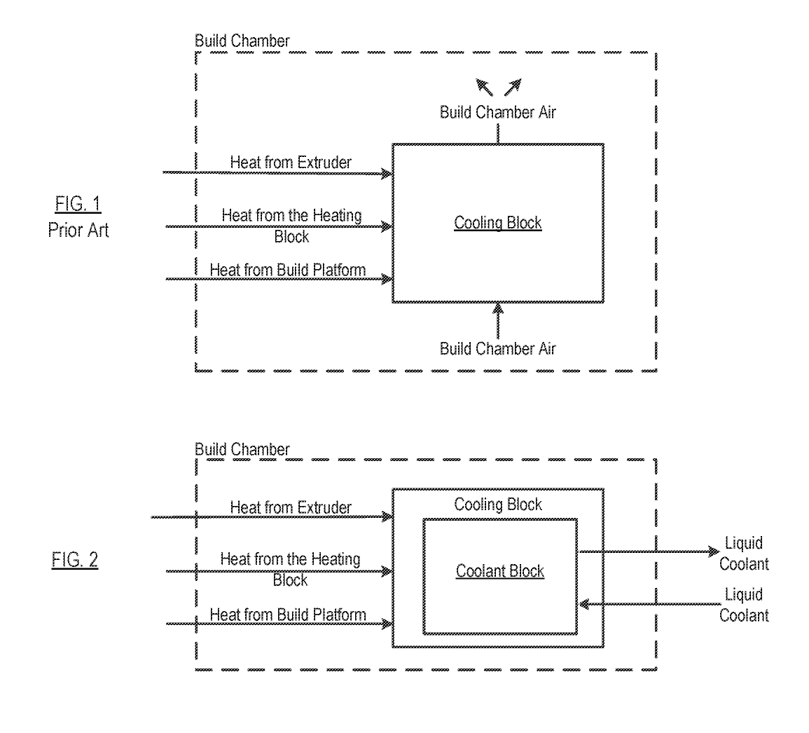

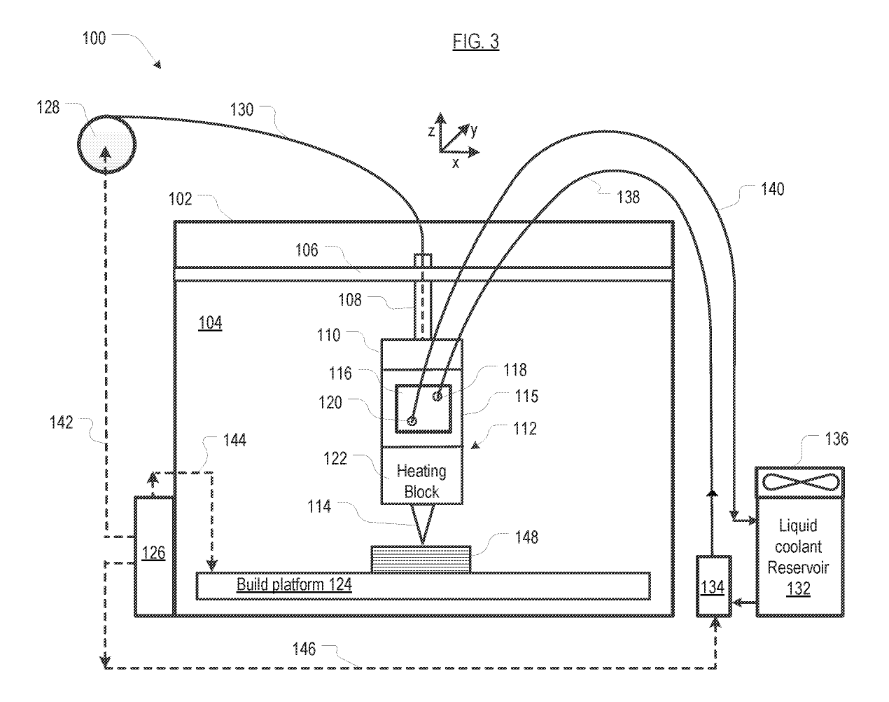

3D printer 100 includes housing 102, which defines build chamber 104. Fixture 110 supports extrusion head 112, which includes nozzle 114. The fixture is movably supported by gantry 106 via arm 108. Gantry 106 enables movement of nozzle 114 in the X direction (left and right in FIG. 1) and Y direction (backward or forward in FIG. 1). Below nozzle 114 is build plate 124, upon which nozzle 124 deposits successive layers of extrudate to build object 148. Build plate 124 is movable in the Z direction (i.e., up and down in FIG. 1), providing 3 degrees-of-freedom to the build.

3D printer 100 also includes controller 126. The controller reads and executes commands from the G-code generated from an outboard computer (not depicted). For example, controller 126 orchestrates the build of object 148, based on build instructions received from the computer, by controlling gantry movement and build plate movement, extrusion rate, and build plate and nozzle temperature via various control signal(s) 142, 144, etc. As is well known in the art, the computer generates the build instructions using, for example, CAD software (for generating a 3D model of the object being printed) and slicing software (for “slicing” the 3D model into planar segments and generating the G-code instruction set).

Fixture 110 accommodates cooling block 115 and heating block 122. The thermal management system is interfaced with cooling block 115 to provide heat exchange therewith. In the illustrative embodiment, the thermal management system includes coolant block 116, liquid coolant reservoir 132, pump 134, fan/radiator 136 and conduits 138 and 140.

In the illustrative embodiment, coolant block 116 is coupled to the surface of cooling block 115. Coolant block 116 contains plural small passages or channels to increase the surface area for heat exchange within coolant block 116. Thermal paste is used at the abutting surfaces of cooling block 115 and coolant block 116 to ensure efficient heat transfer therebetween.

Coolant block 116 accepts liquid coolant, sourced from reservoir 132, at inlet port 120 via coolant feed line 138. The coolant is delivered to coolant block 116 via pump 134, which takes suction from coolant reservoir 132. After picking up heat from cooling block 115, the coolant exits outlet port 120 of coolant block 116 and is conducted via coolant return line 140 to coolant reservoir 132. Fan/radiator 136 exchanges heat between coolant reservoir 132 and the air to remove the heat picked up from cooling block 115. In the illustrative embodiment, the liquid coolant is (room temperature) propylene glycol.

In light of this disclosure, those skilled in the art will be able to devise other arrangements for the thermal management system. A key aspect of such systems is that a liquid coolant is used for cooling the cooling block. In preferred embodiments, the liquid coolant reservoir is situated outside the build chamber of the 3D printer. In some embodiments of a thermal management system consistent with the present teachings, the liquid coolant will at least partially vaporize. Fluids other than propylene glycol can be used as the liquid coolant; it is within the capabilities of those skilled in the art to select such other fluids, consistent with the processing conditions within build chamber 104.

Since the liquid coolant, which in the illustrative embodiment is propylene glycol, is stored outside of the system (i.e., outside of the build chamber), it can cool the coolant block to a significantly lower temperature than a fan that is blowing air from the build chamber across the cooling block. A fan, as used in the prior art, is limited to cooling the block to the temperature of the build chamber. In this regard, it is notable that the build chamber is typically heated in this process to reduce warpage and increase inter-laminar adhesion, as described in the prior art. This chamber temperature can range anywhere from 50 to 200° C.

At 50° C., a fan is still sufficient in providing cooling for lower temperature polymers, such as acrylonitrile butadiene styrene (ABS), polylactic acid (PLA), and polyetherimide (PEI). However, at chamber temperatures closer to 200° C., even these materials would clog when using a fan for cooling. The liquid cooling process disclosed herein is removing heat from the system, thereby enabling the cooling block to be at a lower temperature compared to the build chamber. Thus, the cooling block can be maintained at room temperature even though the build chamber is at 200° C.

As a consequence of the liquid cooling system disclosed herein, cooling block is maintained at or near the temperature of the liquid coolant, which in the illustrative embodiment, is approximately room temperature. Maintained at or near room temperature, polymer filament 130 remains in a solid, glassy state until it enters heating block 122. Within the heating block, filament 130 reaches and exceeds the glass transition temperature, exhibiting the plug state. As previously indicated, the inventors discovered that the length (i.e., time and physical length) of the plug state determines the pressure of the feed system and ultimately the susceptibility of the system to clogging.

To reduce pressure and reduce the occurrence of clogging, the plug state must be as short as possible. When the cooling block is cooled by a fan, as in the prior art, the plug state begins in the cooling block and ends in the heating block when the polymer enters its melt state. Using liquid cooling, such as via a coolant block as disclosed herein, the plug state and melt state of the polymer are restricted to the heating block. This reduction in the length (i.e., time and physical length) of the plug state makes it far easier to process high viscosity and semi-crystalline materials via FFF-based 3D printing.

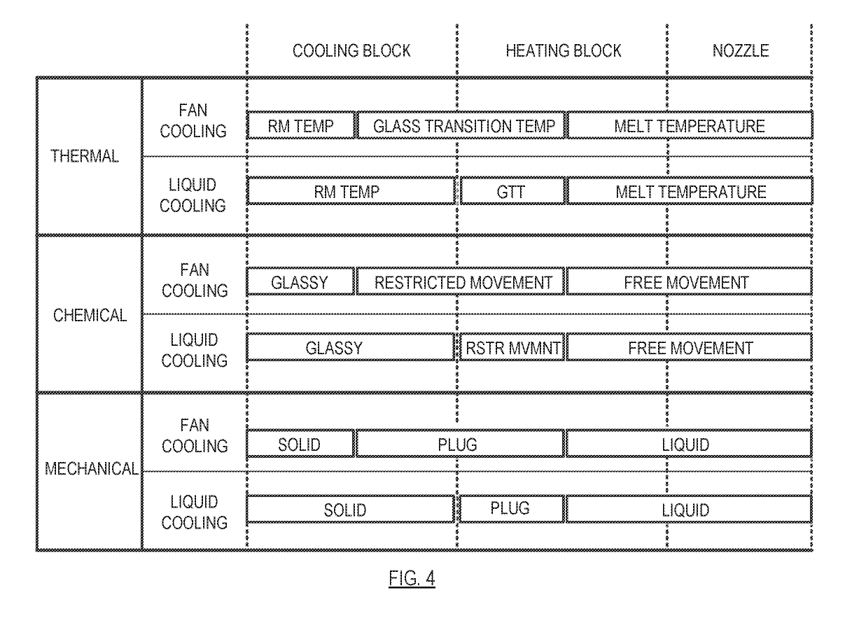

FIG. 4 is a table that provides a comparison, for fan cooling (prior art) and liquid cooling (embodiments of the invention), of the thermal, chemical, and mechanical state of the polymer filament as it progresses through the printer from cooling block to the heating block and finally to the nozzle. This applies to high temperature and/or high viscosity, semi-crystalline polymers such PEEK, PAI, and SRP, as previously discussed, or others known to those skilled in the art.

As to thermal properties, for the prior art, the polymer enters the cooling block at room temperature. Due to the insufficient cooling provided by the fan, the temperature of the polymer increases to and exceeds the glass transition temperature while still in the cooling block. In the heating block, the temperature is increased until the polymer melts.

In accordance with embodiments of the invention, the polymer enters the cooling block at room temperature and, unlike the prior art, remains at or near room temperature while it is in the cooling block. It is only after the polymer leaves the cooling block and enters the heating block that its temperature is raised to the glass transition temperature and, ultimately, to the melting temperature. A comparison between the prior art (fan cooling) and liquid cooling, as disclosed herein, shows that the polymer is at or above the glass transition temperature for a longer period of time for the prior art.

The corresponding chemical state for fan cooling and liquid cooling show that the polymer is in a restricted movement state for a longer period of time for fan cooling as compared to liquid cooling.

In terms of mechanical properties, consistent with the above discussion, the polymer enters the plug stage while in the cooling block and converts to liquid at some point in the heating block when fan cooling is used. In embodiments of the invention, the polymer does not enter the plug state in the cooling block. Rather, it is in the plug state for a relatively short period of time in the heating block.

It is to be understood that although the disclosure teaches many examples of embodiments in accordance with the present teachings, many additional variations of the invention can easily be devised by those skilled in the art after reading this disclosure. As a consequence, the scope of the present invention is to be determined by the following claims.

What is claimed:

1. A modified fused filament fabrication-based 3D printer comprising:
a cooling block;
a thermal management system for cooling the cooling block, wherein the thermal management system uses a liquid coolant for cooling the cooling block;
a heating block disposed downstream of the cooling block, wherein the heating block heats a filament to a glass transition temperature thereof and to a melting point thereof; and
a nozzle for delivering the melted filament to a build plate.

2. The 3D printer of claim 1 wherein the thermal management system comprises a coolant block, wherein the coolant block is attached to the cooling block and is physically adapted to transfer heat from the cooling block, and wherein the coolant block has channels for conveying liquid coolant therethrough.

3. The 3D printer of claim 2 wherein the thermal management system further comprises a liquid-coolant reservoir, wherein the liquid-coolant reservoir stores the liquid coolant.

4. The 3D printer of claim 3 wherein the liquid-coolant reservoir is disposed outside of a build chamber of the modified fused filament fabrication system.

5. The 3D printer of claim 1 wherein the liquid coolant is propylene glycol.

6. The 3D printer of claim 3 wherein the thermal management system further comprises a pump, wherein the pump pumps the liquid coolant from the liquid-coolant reservoir to the coolant block.

7. The 3D printer of claim 6 wherein the thermal management system further comprises a fan and radiator that removes heat from the liquid coolant in the liquid-coolant reservoir.

8. The 3D printer of claim 1 wherein the filament is selected from the group consisting of polyether ether ketone, polyamide-imine, and self-reinforced polyphenylene.

9. A modified fused filament fabrication-based 3D printer comprising:
a cooling block;
a coolant block, wherein the coolant block abuts the cooling block to exchange heat therewith, wherein the coolant block has channels for conveying liquid coolant therethrough;
a heating block disposed downstream of the cooling block; and
an extrusion head comprising a nozzle, wherein the extrusion head receives a polymer that, after being melted by heat delivered from the heating block, is dispensed through the nozzle.

10. The 3D printer of claim 9 wherein the coolant block provides sufficient cooling to the cooling block to maintain a temperature of the polymer below a glass transition temperature thereof until the polymer reaches the heating block.

11. The 3D printer of claim 9 wherein the cooling block, coolant block, heating block, and extrusion head are supported by a fixture, and wherein the fixture is coupled to a gantry that moves the fixture in two dimensions.

12. The 3D printer of claim 11 further comprising a build plate, wherein the build plate is disposed below the nozzle and is movable in a third dimension that is different from the two dimensions in which the fixture moves.

13. The 3D printer of claim 9 further comprising:
a liquid-coolant reservoir that stores liquid coolant; and
a pump, wherein the pump pumps the liquid coolant from the liquid-coolant reservoir to the coolant block.

14. The 3D printer of claim 13, wherein the liquid-coolant reservoir is disposed outside of a build chamber of the 3D printer.

15. A method for operating a 3D printer comprising:
delivering, from a reservoir, liquid coolant to a coolant block;
exchanging heat between the coolant block and a cooling block, wherein the liquid coolant in the coolant block receives the exchanged heat;
returning the liquid coolant to the reservoir; and
removing heat from the reservoir.

16. The method of claim 15 wherein delivering liquid coolant further comprises delivering a sufficient quantity of liquid coolant to the coolant block to maintain a temperature of a polymer that is fed to the 3D printer below a glass transition temperature of the polymer until the polymer reaches a heating block of the 3D printer.

17. The method of claim 15 wherein the liquid coolant is propylene glycol.

18. The method of claim 15 further comprising feeding a polymer to the 3D printer, wherein the polymer is selected from the group consisting of polyether ether ketone, polyamide-imine, and self-reinforced polyphenylene.
